(19) United States
(12) Patent Application Publication
(10) Pub. No.: US 2025/0196667 A1
(43) Pub. Date: Jun. 19, 2025

(54) REFUSE COLLECTION VEHICLE WITH INTEGRATED HYDROGEN-BASED POWER GENERATION

(71) Applicant: The Heil Co., Chattanooga, TN (US)

(72) Inventors: Mark Fraas, Centre, AL (US); Bryan Kelly Stewart, Chattanooga, TN (US)

(21) Appl. No.: 18/980,033

(22) Filed: Dec. 13, 2024

Related U.S. Application Data
(60) Provisional application No. 63/609,595, filed on Dec. 13, 2023.
(60) Provisional application No. 63/680,727, filed on Aug. 8, 2024.

(51) Int. Cl. B60L 50/75; B60L 1/00; B65F 3/02; B65F 3/28

(52) U.S. Cl. CPC B60L 50/75; B60L 1/003; B65F 3/28; B60L 2200/40; B65F 2003/0286

(57) ABSTRACT

Systems and methods for integrating hydrogen fueled power generation systems with a refuse collection vehicle include a refuse collection vehicle including a chassis; a refuse collecting body supported by the chassis; and a power generating assembly supported by the chassis. The power generating assembly includes at least one hydrogen tank; a fuel cell fluidly coupled to the at least one hydrogen tank; and at least one battery electrically connected to the fuel cell. Alternatively, the power generating assembly includes a hydrogen engine coupled to the at least one hydrogen tank; and a generator coupled to the hydrogen engine and the at least one battery.

### CROSS-REFERENCE TO RELATED APPLICATIONS

This application claims the benefit under 35 U.S.C. § 119 (e) of U.S. Patent Application No. 63/609,595 filed Dec. 13, 2023, entitled “Refuse Collection Vehicle with Integrated Fuel Cell” and U.S. Patent Application No. 63/680,727, filed Aug. 8, 2024, entitled “Refuse Collection Vehicle with Integrated Hydrogen-Based Power Generation,” which are incorporated herein by reference in their entirety.

### TECHNICAL FIELD

This disclosure relates to systems and methods for integrating hydrogen based power generation with a refuse collection vehicle.

### BACKGROUND

Refuse collection vehicles collect solid waste and transport the solid waste to landfills, recycling centers, or treatment facilities. In recent years, electric refuse collection vehicles have been introduced in an effort to reduce carbon emissions and hydraulic fluid leaks. Replacing the combustion engines and/or hydraulic pumps of conventional refuse vehicles with electric motors and actuators has raised a host of new design challenges. Thus, methods and equipment for improving electric refuse collection vehicles are sought.

### SUMMARY

In an example implementation, a refuse collection vehicle includes a chassis; a refuse collecting body supported by the chassis; a power generating assembly supported by the chassis. The power generating assembly includes at least one hydrogen tank; a fuel cell fluidly coupled to the at least one hydrogen tank; and at least one battery electrically connected to the fuel cell.

In an aspect combinable with the example implementation, the power generating assembly is coupled to the refuse collecting body.

Another aspect combinable with any of the previous aspects includes a tailgate coupled to the refuse collecting body, where the at least one hydrogen tank, the fuel cell and the at least one battery are disposed on the tailgate.

Another aspect combinable with any of the previous aspects includes one or more natural gas tanks disposed on the tailgate.

In another aspect combinable with any of the previous aspects, the at least one hydrogen tank, the fuel cell and the at least one battery are disposed in a pod attached to a top surface of the refuse collecting body.

In another aspect combinable with any of the previous aspects, the at least one hydrogen tank, the fuel cell and the at least one battery are disposed in a pod attached to a frame rail of the refuse collecting body.

Another aspect combinable with any of the previous aspects includes at least one body component of the body, the at least one body component includes a refuse loading assembly, a refuse packing assembly, or a refuse ejection assembly.

In another aspect combinable with any of the previous aspects, the at least one body component includes one or more electric actuators, where the at least one battery is configured to provide electrical power to the one or more electric actuators of at least one body component.

Another aspect combinable with any of the previous aspects includes a hydraulic power system comprising an electrically powered hydraulic pump. The hydraulic pump is configured to receive electrical power from the at least one battery. The at least one body component includes one or more hydraulic actuators.

Another aspect combinable with any of the previous aspects includes a power management system including one or more processors configured to perform operations including measuring power usage of one or more electrical components; and controlling power output of the fuel cell and the at least one battery.

In another aspect combinable with any of the previous aspects, the chassis includes a chassis battery pack and an electric motor configured to propel the vehicle. The fuel cell is configured to charge the chassis battery pack.

In another aspect combinable with any of the previous aspects, the chassis includes an internal combustion engine configured to propel the vehicle.

Another aspect combinable with any of the previous aspects includes one or more natural gas tanks coupled to the refuse collecting body, the one or more natural gas tanks fluidly coupled to the internal combustion engine.

In another aspect combinable with any of the previous aspects, the refuse collection vehicle includes a front loader refuse collection vehicle, a side loader refuse collection vehicle, or a rear loader refuse collection vehicle.

In another example implementation, a method of operating a refuse collecting body of a refuse collection vehicle includes receiving a command to operate a component of the refuse collecting body; in response to receiving the command, generating one or more control signals to operate the component of the refuse collecting body; monitoring energy usage of the refuse collecting body; determining that at least one battery needs to be recharged based on the energy usage of the refuse collecting body; and selectively operating one or more valves of one or more hydrogen tanks to control a flow of hydrogen from the one or more hydrogen tanks to a fuel cell to generate electricity to recharge the at least one battery.

In an aspect combinable with the example implementation, the component includes a refuse loading assembly, a refuse packing assembly, or a tailgate.

In another aspect combinable with any of the previous aspects, the component includes an electric hydraulic pump.

Another aspect combinable with any of the previous aspects includes hydraulically actuating the component of the refuse collecting body using power supplied by the electric hydraulic pump.

In another aspect combinable with any of the previous aspects, the component includes a refuse loading assembly, a refuse packing assembly, or a tailgate.

Another aspect combinable with any of the previous aspects includes electrically actuating the component of the refuse collecting body using stored in the at least one battery.

In another example implementation, a refuse collection vehicle includes a chassis; a refuse collecting body supported by the chassis; a power generating assembly supported by the chassis. The power generating assembly includes at least one hydrogen tank; a hydrogen engine fluidly coupled to the at least one hydrogen tank; a generator mechanically coupled to the hydrogen engine; and at least one battery electrically connected to the generator.

In an aspect combinable with the example implementation, the power generating assembly is coupled to the refuse collecting body.

Another aspect combinable with any of the previous aspects includes a tailgate coupled to the refuse collecting body, where the at least one hydrogen tank, the hydrogen engine, the generator, and the at least one battery are disposed on the tailgate.

Another aspect combinable with any of the previous aspects includes one or more natural gas tanks disposed on the tailgate.

In another aspect combinable with any of the previous aspects, the at least one hydrogen tank, the hydrogen engine, the generator, and the at least one battery are disposed in a pod attached to a top surface of the refuse collecting body.

In another aspect combinable with any of the previous aspects, the at least one hydrogen tank, the hydrogen engine, the generator, and the at least one battery are disposed in a pod attached to a frame rail of the refuse collecting body.

Another aspect combinable with any of the previous aspects includes at least one body component of the body, the at least one body component including a refuse loading assembly, a refuse packing assembly, or a refuse ejection assembly.

In another aspect combinable with any of the previous aspects, the at least one body component includes one or more electric actuators, where the at least one battery is configured to provide electrical power to the one or more electric actuators of the at least one body component.

Another aspect combinable with any of the previous aspects includes a hydraulic power system including an electrically powered hydraulic pump, wherein the hydraulic pump is configured to receive electrical power from the at least one battery; wherein the at least one body component comprises one or more hydraulic actuators.

Another aspect combinable with any of the previous aspects includes a hydraulic power system and a power takeoff coupled to the hydrogen engine, where the hydraulic power system is configured to receive mechanical energy from the hydrogen engine through the power takeoff to operate one or more hydraulic actuators of the at least one body component.

In another aspect combinable with any of the previous aspects, the power takeoff includes a hybrid electric power takeoff.

Another aspect combinable with any of the previous aspects includes a planetary gearbox, where the hydrogen engine is mechanically coupled to the generator and the power takeoff by the planetary gearbox.

Another aspect combinable with any of the previous aspects includes a power management system including one or more processors configured to perform operations including measuring power usage of one or more electrical components; and controlling power output of the hydrogen engine, the generator, and the at least one battery.

In another aspect combinable with any of the previous aspects, the chassis includes a chassis battery pack and an electric motor configured to propel the vehicle, where the hydrogen engine and generator are configured to charge the chassis battery pack.

In another aspect combinable with any of the previous aspects, the chassis includes an internal combustion engine configured to propel the vehicle.

Another aspect combinable with any of the previous aspects includes one or more natural gas tanks coupled to the refuse collecting body, the one or more natural gas tanks fluidly coupled to the internal combustion engine.

In another aspect combinable with any of the previous aspects, the refuse collection vehicle includes a front loader refuse collection vehicle, a side loader refuse collection vehicle, or a rear loader refuse collection vehicle.

In another example implementation, a method of operating a refuse collecting body of a refuse collection vehicle includes receiving a command to operate a component of the refuse collecting body; in response to receiving the command, generating one or more control signals to operate the component of the refuse collecting body; monitoring energy usage of the refuse collecting body; determining that at least one battery needs to be recharged based on the energy usage of the refuse collecting body; and selectively operating one or more valves of one or more hydrogen tanks to control a flow of hydrogen from the one or more hydrogen tanks to a hydrogen engine to generate electricity to recharge the at least one battery.

In an aspect combinable with the example implementation, the component includes a refuse loading assembly, a refuse packing assembly, or a tailgate.

In another aspect combinable with any of the previous aspects, the component includes a hydraulic pump coupled to the hydrogen engine by a power takeoff.

Another aspect combinable with any of the previous aspects includes hydraulically actuating the component of the refuse collecting body using power supplied by the hydraulic pump.

In another aspect combinable with any of the previous aspects, the component includes a refuse loading assembly, a refuse packing assembly, or a tailgate.

Another aspect combinable with any of the previous aspects includes electrically actuating the component of the refuse collecting body using energy stored in the at least one battery.

In another example implementation, a refuse collection vehicle includes a chassis; a refuse collecting body supported by the chassis; a power generating assembly supported by the chassis. The power generating assembly includes at least one hydrogen tank; a hydrogen engine fluidly coupled to the at least one hydrogen tank; a power takeoff coupled to the hydrogen engine; and a hydraulic pump configured to receive mechanical energy from the hydrogen engine through the power takeoff.

In an aspect combinable with the example implementation, the power generating assembly is coupled to the refuse collecting body.

another aspect combinable with any of the previous aspects includes a tailgate coupled to the refuse collecting body, where the power generating assembly is disposed on the tailgate.

Another aspect combinable with any of the previous aspects includes one or more natural gas tanks disposed on the tailgate.

Another aspect combinable with any of the previous aspects includes at least one body component of the body, the at least one body component including a refuse loading assembly, a refuse packing assembly, or a refuse ejection assembly.

In another aspect combinable with any of the previous aspects, the at least one body component includes one or more hydraulic actuators pressurized by the hydraulic pump.

In another aspect combinable with any of the previous aspects, the chassis includes an internal combustion engine configured to propel the vehicle.

Another aspect combinable with any of the previous aspects includes one or more natural gas tanks coupled to the refuse collecting body, the one or more natural gas tanks fluidly coupled to the internal combustion engine.

In another aspect combinable with any of the previous aspects, the refuse collection vehicle includes a front loader refuse collection vehicle, a side loader refuse collection vehicle, or a rear loader refuse collection vehicle.

Particular implementations of the subject matter described in this specification may realize one or more of the following advantages.

For example, in some implementations, a refuse collection vehicle includes a fully or partially electric body—meaning that one or more body components like arms, grabbers, packers, and/or tailgates are driven by electric motors and actuators—which decreases fuel costs for operating the refuse vehicle. In some implementations, integration of a hydrogen fuel cell or a hydrogen fueled engine with the refuse collection vehicle can increase the operation time of the electric body before needing to be recharged. For instance, the hydrogen fuel cell or hydrogen engine can generate sufficient electricity to maintain the charge in the batteries of a refuse collection vehicle throughout the duration of a refuse collection route or over the course of multiple collection routes, eliminating downtime caused by having to recharge the batteries from an external source (e.g., a charging station).

In addition, the integrated fuel cell or hydrogen engine can allow an electric refuse collection vehicle to function with a smaller battery or battery pack as compared to such a vehicle without a fuel cell or hydrogen engine. The reduced weight of the smaller battery or battery pack may facilitate abiding jurisdictional weight limits and/or allow the refuse collection vehicle to collect more refuse before offloading at a waste facility (e.g., a landfill).

In refuse collection vehicles that also include electric propulsion systems, the integrated fuel cell or hydrogen engine can increase the range of the refuse collection vehicle by recharging the chassis batteries in addition to powering the body components. Integrating the fuel cell or hydrogen engine into the body enables a location selection which optimizes the space available in the body and optimizes the weight distribution.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIGS. 1A-1B are perspective side views of an example refuse collection vehicle.

FIGS. 2A-2C are perspective and side views of example refuse collection vehicles including actuated body components.

FIG. 3 is a perspective view of an example tailgate for a refuse collection vehicle.

FIG. 4A is an exploded view of the example tailgate of FIG. 3.

FIG. 4B is an exploded view of another example tailgate.

FIGS. 4C and 4D are block diagrams of power generation systems including a hydrogen engine.

FIG. 5A is a side view of an example refuse collection vehicle showing example storage locations for gas cylinders.

FIG. 5B is a perspective view of an example pod including gas cylinders to be mounted on the top of a refuse collection vehicle.

FIG. 5C is a perspective view of another example pod including a fuel cell, battery, and gas cylinders to be mounted on the top of a refuse collection vehicle.

FIG. 6 is a block diagram of an example power system for a refuse collection vehicle.

FIG. 7 is a flow chart of an example method of operating a refuse collection vehicle.

FIG. 8 is a schematic illustration of an example control system or controller of the refuse collection vehicle.

### DETAILED DESCRIPTION

Various embodiments of the present disclosure feature a refuse collection vehicle including a fuel cell or a hydrogen engine with an attached generator, hydrogen tanks, and a battery pack. The fuel cell or hydrogen engine is configured to generate electricity to be stored in the battery pack. The stored electricity can be used to power one or more body components of the refuse collection vehicle and/or the vehicle's propulsion system.

Generating electricity onboard the refuse collection vehicle reduces and/or eliminates the reliance of an electrically powered refuse collection vehicle on an external electricity source (e.g., a city or municipality power grid). In some locations, hydrogen may be more plentiful and/or more easily accessible than external electricity sources suitable to recharge the battery packs. Generating electricity onboard the refuse collection vehicle can decrease the infrastructure necessary to charge a fleet of refuse collection vehicles. For example, the hydrogen tanks of the refuse collection vehicle can be refilled from a source of hydrogen within a few minutes allowing many vehicles to be refilled from the same source. Without generating the electricity onboard, many battery chargers may be needed to recharge a fleet of refuse collection vehicles since charging the battery can take on the order of hours to fully charge.

Generating electricity onboard the refuse collection vehicle allows a smaller battery or battery pack to be used onboard the refuse collection vehicle without a corresponding reduction in the range and/or operating time of the refuse collection vehicle. In some implementations, the onboard fuel cell increases the range and/or operating time of the refuse collection vehicle between refuelling and/or recharging.

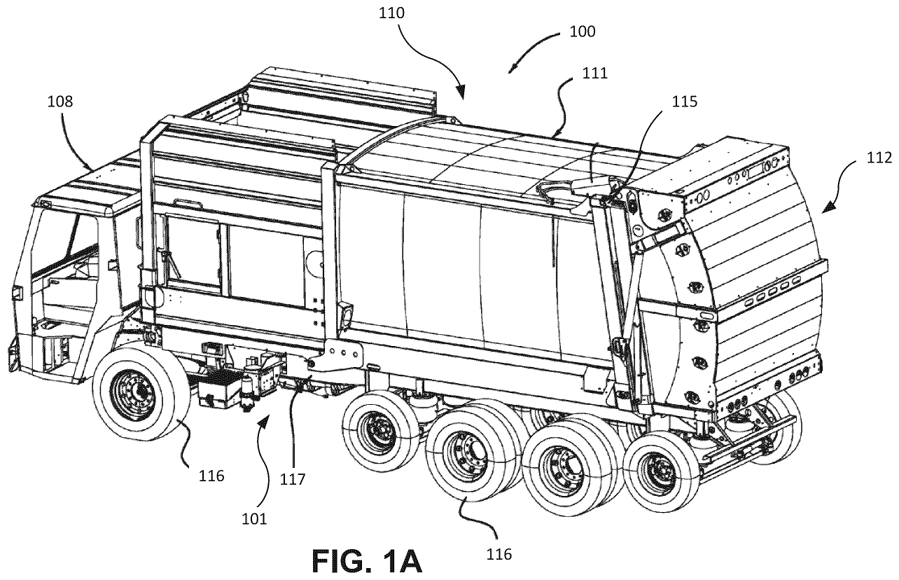

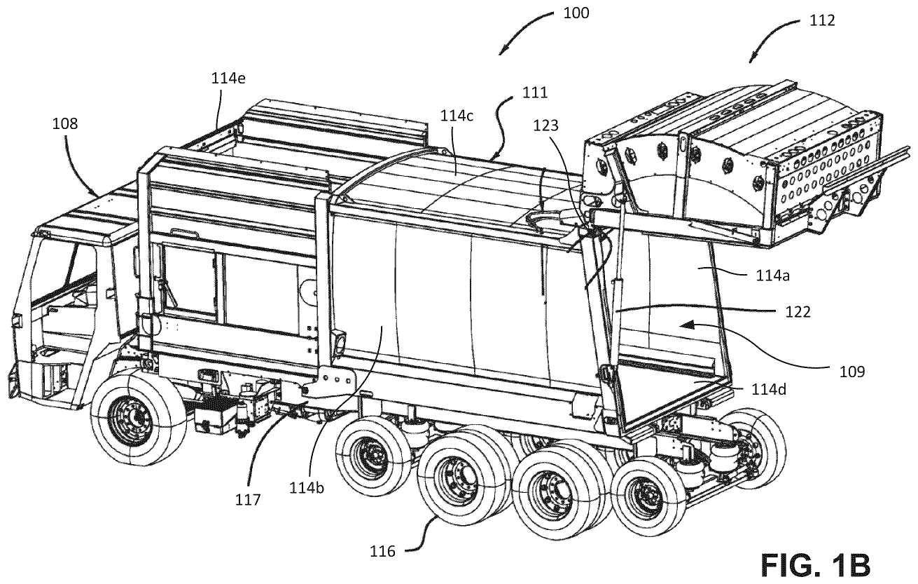

FIGS. 1A-1B depict a refuse collection vehicle 100. The refuse collection vehicle 100 is illustrated as a front loader, but the refuse collection vehicle 100 can be a side loader, a rear loader, or another type of refuse collection vehicle such as a skid-loader, a tele-handler, a plow truck, or a boom lift.

The refuse collection vehicle 100 has a wheeled chassis 101. The wheeled chassis 101 includes a lower frame 117 and road wheels 116 attached to the lower frame 117. The refuse collection vehicle 100 also includes a cabin 108 (e.g., a driver's cab), a refuse collection body 110 carried by the wheeled chassis 101, and a tailgate 112 coupled to the body 110. Propulsion of the chassis 101 of the refuse collection vehicle 100 can be powered by a variety of types of engines including, but not limited to, an electric engine, a diesel engine, or a compressed natural gas (CNG) engine.

The refuse collection body 110 has an interior volume 109 between a pair of side walls 114a-b, a top surface 114c (e.g., roof), a floor 114d, and a front wall 114e. The interior volume 109 includes a refuse storage container 111 that receives and stores refuse collected by the refuse collection vehicle 100. Note that within this disclosure, we refer to the tailgate (e.g., tailgate 112) as a separate component from the body (e.g., body 110), such that the interior volume of the tailgate is distinct from the interior volume of the body.

The tailgate 112 is secured to the body 110 by hinges 115. The hinges 115 are connected around pivot pins 123 so that the tailgate 112 can rotate with respect to the body 110. The tailgate 112 can be rotated by one or more actuators 122. The actuators 122 can be electric actuators or hydraulic actuators.

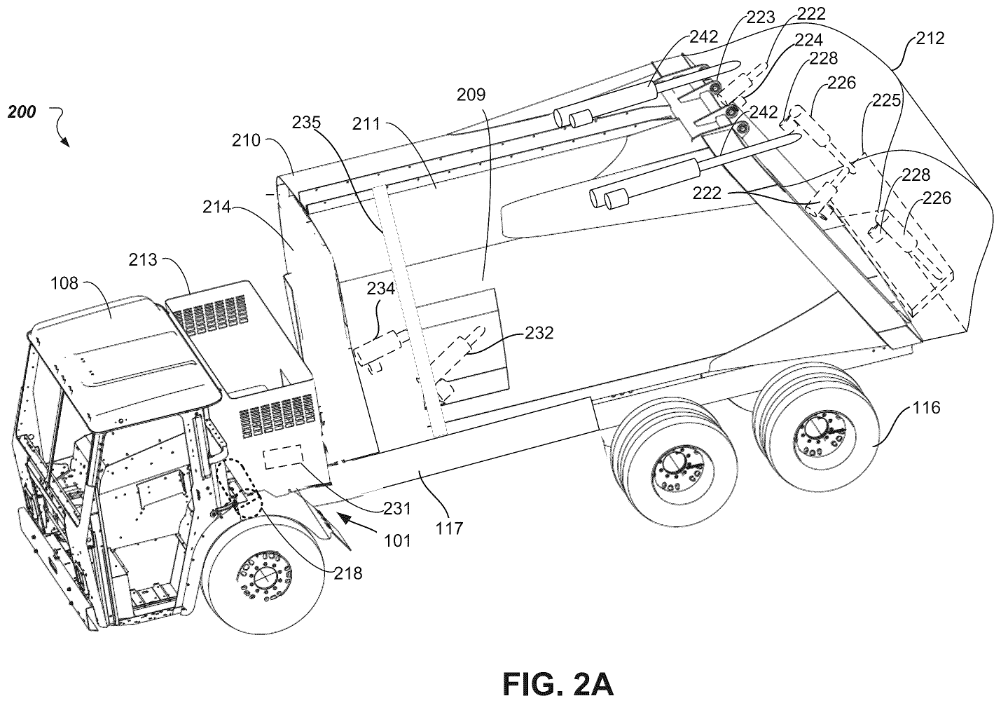

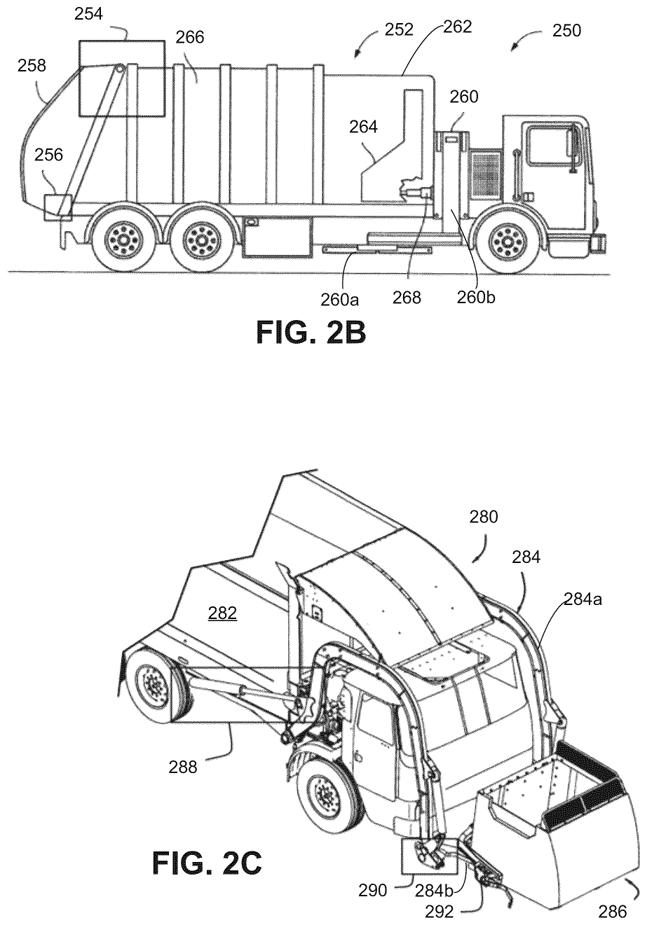

Various electrically actuated body components are depicted in FIGS. 2A, 2B, and 2C in refuse collection vehicles 200, 250, and 280. For example, body components can include a lift arm (e.g., 260b, 284a), a fork mechanism (e.g., 284b), a grabber mechanism (e.g., 260a), a back gate or tailgate (e.g., 112, 212, 258), a hopper to collect refuse during operation (e.g., 262), and a packer (e.g., 225, 264).

Referring to FIG. 2A, an example rear-loader refuse collection vehicle 200 is depicted. The refuse collection vehicle 200 can be fully electric. For example, the fully-electric refuse collection vehicle 200 can have electric actuators (instead of hydraulic actuators) and one or more electric propulsion motors 218 connected to one or more wheels 116 of the chassis 101. The electric propulsion motors 218 can be configured, for example and without limitation, as hub motors, belt-drive motors, or mid-drive motors. The electric propulsion motors 118 can be, for example and without limitation, DC series motors, brushless DC motors, permanent magnet synchronous motors (PMSM), AC induction motors (e.g., three-phase AC induction motors), or switched reluctance motors (SRM). One or more battery packs can power the electric actuators and the propulsion motors 218. Additionally, the refuse collection vehicle 200 can have electric actuators but the propulsion can be non-electric (e.g., the chassis 101 can be powered by a diesel or propane engine).

The refuse collection body 210 includes a powered tailgate 212 and a refuse packer 225. The powered tailgate 212 and the refuse packer 225 can both be driven by electric actuators. For example, the powered tailgate 212 is driven by one or more electric tailgate motors 224 of one or more electric actuators 222, and the refuse packer 225 is driven by one or more electric packer motors 228 of one or more electric actuators 226. Additionally, the refuse collection vehicle 200 can have other electrically-powered actuators in place of other typical hydraulic actuators. For example, the refuse collection vehicle 200 can have ejector electric actuators 234, body-raise electric actuators 232, and overhead container lift actuators 242. In the case of front-loader and side-loader vehicles, the arms or forks that lift the trash containers can also be powered by electric motors and actuators.

Each electric tailgate motor 224 is part of or is connected to a respective electric tailgate actuator 222 that is attached to the powered tailgate 212. For example, the electric tailgate motor 224 is attached (e.g., by a gearbox) to the electric tailgate actuator 222 to control, by rotation of a shaft of the motor 224, the electric tailgate actuator 222. The electric actuators 222, 226, 232, 234, 242 of the collection body 210 can be linear actuators or rotary actuators.

The electric tailgate actuator 222 can be, for example and without limitation, a ball screw actuator, a lead screw actuator, or a rotary style electric actuator. For example, the electric tailgate actuator 222 can be a linear actuator. In the case of a linear actuator, the electric tailgate actuator 222 can push open, by extending an arm of the actuator 222, the powered tailgate 212. Extension of the actuator 222 causes the tailgate 212 to rotate about a pivot 223, opening the refuse storage compartment 211. Thus, the powered tailgate 212 is electrically opened and closed to unload the waste material stored in the refuse storage compartment 211.

Rotary actuator assemblies can include an electric motor that drives a gear reduction “box” which transmits power via a keyed or splined shaft to the electric tailgate or the corresponding component of the vehicle 200. The actuators 222, 226, 232, 234, 242 of the refuse collection body 210 can be custom-made for the specific power, force, speed, and displacement required to move the components of the collection body 210.

The electric tailgate motors 224 can be, for example and without limitation, DC series motors, brushless DC motors, permanent magnet synchronous motors (PMSM), AC induction motors (e.g., three-phase AC induction motors), or switched reluctance motors (SRM).

Similar to the electric tailgate motors 224, each electric packer motor 228 is part of or is connected to a respective electric packer actuator 226. Each electric packer actuator 226 is attached to the refuse packer 225 to move the refuse packer 225. The electric packer motor 228 is attached (e.g., by a gearbox) to the electric packer actuator 226 and controls, by rotation of a shaft of the motor 228, the refuse packer 225. The electric packer actuators 226 move the packer 225 to pack the waste material by retracting or extending an arm of the actuator 226. The linear electric packer actuators 226 can be similar to the electric tailgate actuators 222 and the electric packer motors 228 can be similar to the electric tailgate motors 224.

The refuse collection vehicle 200 can also include a battery housing 213 that stores a chassis battery pack 231. The chassis battery pack 231 can include multiple battery cells (e.g., lithium-ion battery cells) that provide electrical power to the electric propulsion motors 218, to the electronic components of the chassis 101 (e.g., headlights and taillights) and to the electric components of the cabin 108 (e.g., interior lights, navigation, air conditioning, radio, etc.).

FIG. 2B illustrates an example side-loader refuse collection vehicle 250. Refuse collection vehicle 250 includes an all-electric vehicle body 252, including an electrically actuated tailgate open/close system 254 and an electrically actuated tailgate locking mechanism 256 for tailgate 258. While not depicted in FIG. 2B, the tailgate open/close system 254 and the tailgate locking mechanism 256 can be integrated into a single system that both closes and locks the tailgate or unlocks and opens the tailgate. Refuse collection vehicle 250 further includes a side loader assembly 260 configured to load refuse into the hopper 262. The side loader assembly 260 can include substantially any suitable electrically actuated grabber mechanism 260a (for grabbing a refuse container) and an electrically actuated side loader arm 260b (configured to move the grabber in and out and up and down with respect to the body 252).

Refuse collection vehicle 250 includes an ejector 264 (also referred to as an ejector panel, a packer, and a packer panel, among other terms) deployed in the body 252 within the refuse collection storage container 266. The ejector 264 is configured to translate between forward (retracted) and rearward (extended) positions in a direction substantially parallel with a longitudinal axis of the body 252 of the refuse collection vehicle 250. The refuse collection vehicle 250 further includes an electric ejector actuator 268 configured to translate the ejector 264 between the retracted and extended positions. The vehicle may include substantially any suitable ejector actuator 268, for example, including an electric motor powering a rack and pinion configuration in which the ejector panel is coupled to the rack or an electric motor powering a lead screw or ball screw.

The ejector 264 is generally retracted towards the front of the vehicle 250 while the vehicle 250 is collecting refuse into the hopper 262, for example, via a side loader assembly 260 or a front loader assembly. For example, as depicted in FIG. 2B, the ejector 264 is retracted to the front of the hopper 262 (adjacent to the cab). When the hopper 262 is full (or at any other suitable time determined by the operator), the ejector 264 can be electrically actuated toward the rear of the vehicle 250 to empty the hopper 262 and compact the refuse in the storage container 266.

Turning now to FIG. 2C, an example front loader refuse collection vehicle 280 is depicted including vehicle body 282. Refuse collection vehicle 280 includes a front-loader assembly 284 configured to load refuse into the vehicle body 282 (e.g., up and over the cab in the depicted implementation). A front-loader assembly 284 includes electrically actuated loader arms 284a supporting a plurality of forks 284b that are sized and shaped to engage a dumpster or a carry can 286. The loader arms can be actuated using substantially any suitable electric actuators 288, for example including linear actuators. The forks can also be electrically actuated by electric actuators 290, for example, via an electric motor, to rotate the forks up and down about a pivot.

With continued reference to FIG. 2C, a carry can 286 is shown deployed on the front loader assembly 284. The carry can includes a side loader assembly 292 similar to the side loader assembly 260 described above. Side loader assembly 292 is configured to load refuse into the carry can 286 and can include substantially any suitable electrically actuated grabber mechanism (for grabbing a refuse container) and an electrically actuated arm (configured to move the grabber in and out and up and down with respect to the can 286).

In some implementations, some of the body components shown in FIGS. 2A, 2B, and 2C can be electrically actuated and some of the body components can be hydraulically actuated. For example, instead of being driven by electric actuators 226, the tailgate 212 can be moved by hydraulic actuators. Alternatively, or additionally, ejector assembly 264 can be hydraulically actuated by actuator 268. This can be accomplished with a local oil reservoir or with a larger oil reservoir that serves multiple hydraulic actuation points. A pump with an electric motor can be used to pressurize the hydraulic system and actuate the hydraulic actuators. In this manner, the mechanical advantages of hydraulic systems are maintained while powering the hydraulic system with electricity. In implementations with a hydrogen engine, a power takeoff coupled to the hydrogen engine can be connected to the hydraulic pump to pressurize the hydraulic system.

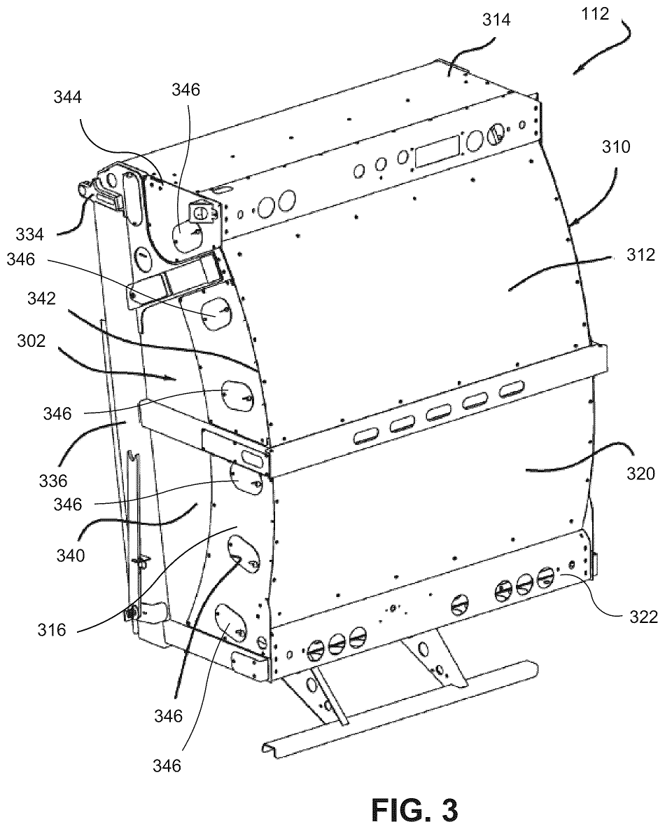

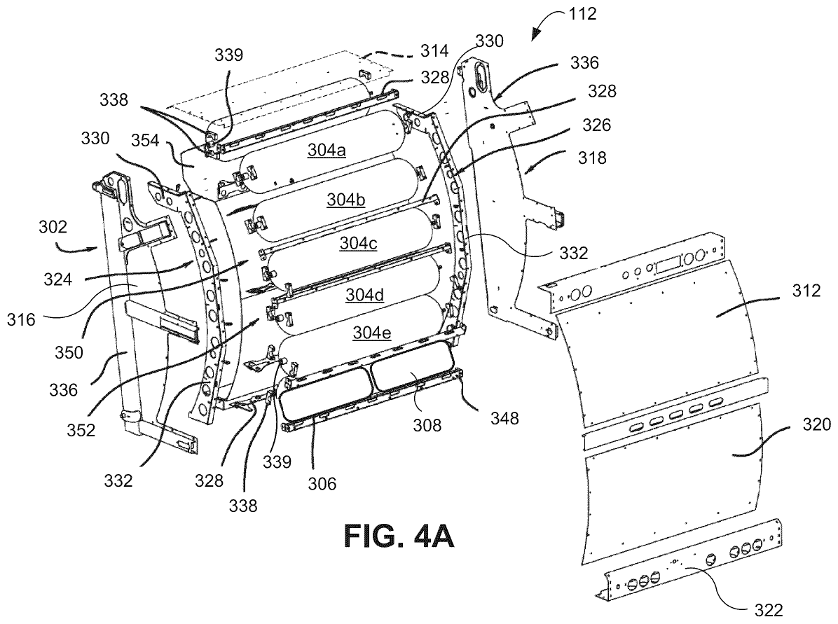

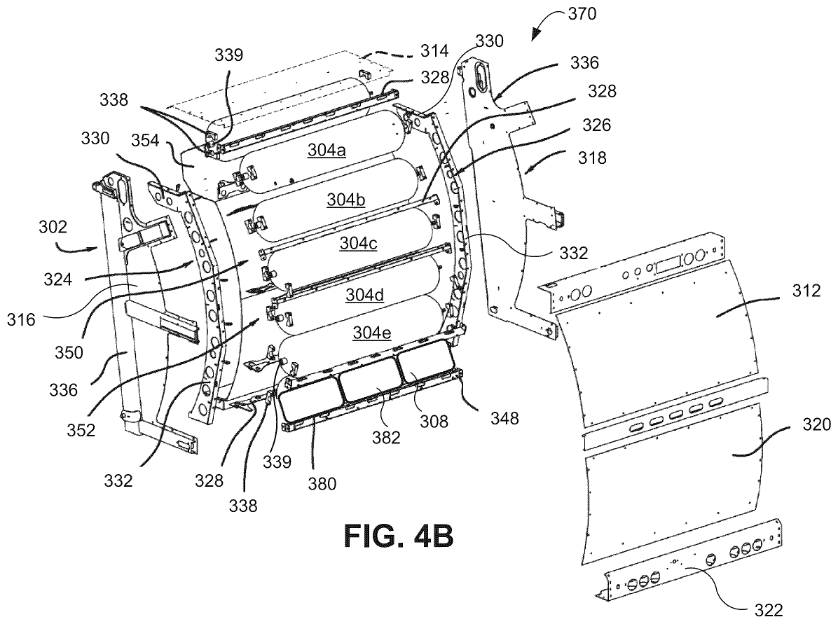

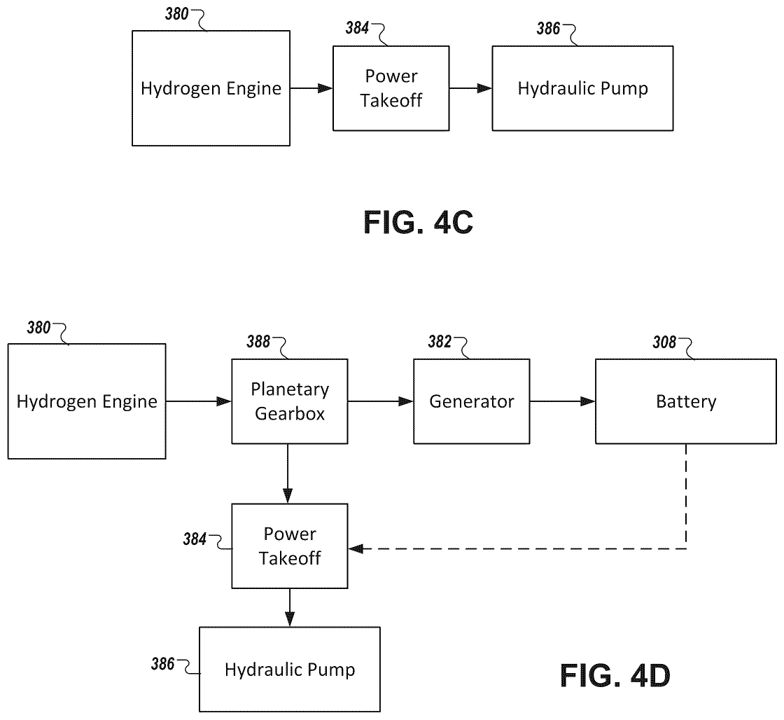

FIGS. 3 and 4A illustrate an example tailgate 112 for a refuse collection vehicle 100, 200, 250, 280 that supports one or more gas tanks, a fuel cell, and a battery pack. The tailgate 112 includes a framework 302, a plurality of gas tanks 304a-e (collectively referred to as gas tanks 304), a fuel cell 306, a battery pack 308 and a cover 310. The cover 310 includes a front portion 312, a top portion 314, side portions 316, 318, a back portion 320, and a bottom portion 322. The cover portions 312-322 surround the framework 302, gas tanks 304, fuel cell 306, and battery pack 308 to prevent access to the gas tanks 304, fuel cell 306 and battery pack 308. In addition, the cover portions 312-322 can prevent fluids or debris exterior to the vehicle from contacting the gas tanks 304, fuel cell 306, and battery pack 308.

The tailgate framework 302 includes a pair of side beams 324, 326 which are substantially identical. Thus, the explanation of one of the side beams 324, 326 will apply to both of the side beams 324, 326. A plurality of cross members 328 connects the side beams 324, 326 together. The side beams 324, 326 have a first portion 330 and a second portion 332. The first portion 330 is angled with respect to the second portion 332. The second portion 332 has an overall arcuate design and curves longitudinally between the top and bottom of the tailgate 112. The first portion 330 is planar and is at the top of the tailgate 112. The hinges 334 are secured to an outer reinforcement member 336 of the cover side portions 316, 318.

The tailgate 112 includes a plurality of saddle blocks 338, and each saddle block 338 receives an end 339 of a gas tank 304. The saddle blocks 338 maintain the tanks 304 on the framework 302. The saddle blocks 338 are fastened to the side beams 324, 326. Combining the tanks 304 with the side beams 324, 326 and the framework 302, creates a desirable shape with a strong, lightweight design.

The cover side portions 316, 318 of the tailgate 112 include an outer reinforcement member 336 and a body 340 attached to the reinforcement member 336. The body 340 has an overall arcuate edge 342, which follows the side beams 324, 326, that mate with the front and bottom cover portions 312, 322. The body portion 340 includes a planar top edge 344 that couples with the top cover portion 314. The side covers 316, 318 include a plurality of apertures 346 that enable access to the tanks 304 for filling and inspection purposes. A plurality of cross members 348 are secured between the side beams 324, 326. The cross members 348 enable the cover portions 312, 314, and 322 to be secured to the framework 302, such as by being bolted to the cross members 328.

The top cover portion 314 has an overall L-shape following the contour of the straight edge 344 of the cover side portions 316, 318 as well as an additional edge that is perpendicular to the top edge 344. The cover portion 312 has an overall rectangular design and can be bolted or riveted or the like to the cross members 348. The bottom cover portion 322 has an overall L-shape for following the contour of the arcuate portion of the side walls as well as the straight edge or the planar bottom portion of the side covers 316, 318.

The tailgate 112 includes a chamber 350 defined by the cover portions 312-322 for housing the gas tanks 304. The chamber 350 has an arcuate portion 352 as well as a straight top portion 354. The chamber top portion 354 enables an additional tank to be positioned at the top of the tailgate 112. This provides for an additional volume of gas.

The tailgate 112 has numerous advantages. For example, the cover portions 312-322 provide an aesthetic appearance to the tailgate 112. Also, the tailgate 112 does not extend above the height of the refuse collection vehicle 100, 200, 250, 280. Additionally, by providing the gas tanks 304 at the rear of the refuse collection vehicle 100, 200, 250, 280, the tailgate 112 reduces the weight on the front axle. Also, the tailgate 112 can be raised and lowered without obstructing the container 111.

One or more of the gas tanks 304 supported by the tailgate 112 are hydrogen gas tanks. For example, gas tanks 304d-e are hydrogen gas tanks. The hydrogen gas tanks 304d-e are fluidly coupled to the fuel cell 306 to provide hydrogen gas to the fuel cell 306 to generate electricity. The hydrogen gas tanks 304d-e can be serially linked together or linked in parallel. Each of the gas tanks 304 includes a valve and a pressure regulator. Each gas tank 304 can also include a pressure gauge to monitor the pressure within the gas tank. Gas tanks 304a-c can also be hydrogen gas tanks to provide additional fuel for the fuel cell. Alternatively, one or more of the gas tanks 304 can be a compressed natural gas (CNG) tank to provide additional fuel to a CNG internal combustion engine of the chassis 101 of the refuse collection vehicle 100, 200, 250, 280.

The fuel cell 306 is operable to generate electricity by receiving hydrogen gas into the fuel cell from one or more of the gas tanks 304. The fuel cell 306 is electrically coupled to the battery 308. The electricity generated by the fuel cell 306 can charge the battery 308 increasing the time between charging the battery 308 from a source external to the refuse collection vehicle 100, 200, 250, 280, or in some implementations, eliminating the need to charge the battery 308 from sources external to the refuse collection vehicle 100, 200, 250, 280.

The gas tanks 304, fuel cell 306, and battery 308 form a power generation system that is configured to operate body components of the refuse collection vehicle 100, 200, 250, 280. For example, the ejector 264, the loader 2620. 284, 292, and the tailgate 112, 212 can be powered by the power generation system.

FIG. 4B is an exploded view of an alternative implementation of a tailgate 370 including a hydrogen engine 380 and a generator 382. Tailgate 370 is substantially the same as tailgate 112 except the hydrogen engine 380 and the generator 382 are used in place of the fuel cell 306. The hydrogen engine 380 is fluidly coupled to one or more of the gas tanks 304. The hydrogen engine 380 combusts hydrogen gas received from the gas tanks 304 to generate mechanical energy. The hydrogen engine 380 is mechanically coupled to the generator 382 to convert the mechanical energy generated by the hydrogen engine 380 into electricity. The generator 382 is electrically coupled to a battery 308 and is configured to charge the battery 308, which can increase the time between charging the battery 308 from a source external to the refuse collection vehicle 100, 200, 250, 280, or in some implementations, eliminating the need to charge the battery 308 from sources external to the refuse collection vehicle 100, 200, 250, 280.

The gas tanks 304, hydrogen engine 380, generator 382, and battery 308 form a power generation system that is configured to operate body components of the refuse collection vehicle, 200, 250, 280. For example, the ejector 264, the loader 260, 284, 292, and the tailgate 370 can be powered by the power generation system.

As with the fuel cell 306, placing the hydrogen engine 380 and the generator 382 in the tailgate 112 of the refuse collection vehicle 100 redistributes the weight of the refuse collection vehicle 100 off of the front-axle. The weight redistribution can improve the performance and handling of the refuse collection vehicle 100.

In some implementations, the hydrogen engine 380 can be mounted on a rotatable mounting, such as a gimble system, that is coupled to the tailgate 370. The gimble system can enable the hydrogen engine 380 to maintain a horizontal orientation (e.g., a normal operating orientation for the hydrogen engine 370) independently of the orientation of the tailgate 370. For example, the hydrogen engine 380 can be in the horizontal orientation when the tailgate 370 is closed (e.g., lowered position), and the hydrogen engine 380 can maintain its horizontal orientation when the tailgate 370 is in the raised position due to rotation of the rotatable mounting coupled to the engine 380 and the tailgate 370. Maintaining a horizontal orientation of the hydrogen engine 380 when the tailgate 370 is raised or lowered enables the engine fluids (e.g., oil and coolant) to remain in designated portions of the hydrogen engine 370 (e.g., oil pan, coolant reservoir, etc.).

FIG. 4C is a block diagram of a power generation system for a refuse collection vehicle including hydraulic actuators. The power generation system includes the hydrogen engine 380 and a hydraulic pump 386 to operate one or more hydraulic actuators of body components of the refuse collection vehicle. The hydraulic pump 386 is coupled to the hydrogen engine 380 through a power takeoff (PTO) 384. The PTO 384 transfers mechanical energy from the hydrogen engine 380 to the hydraulic pump 386 to pressurize the hydraulic actuators.

FIG. 4D is a block diagram of an alternative implementation of the power generation system that can be used on a refuse collection vehicle with hydraulic and electric actuators. The hydrogen engine 380 is coupled to both a generator 382 and a PTO 384 through a planetary gearbox 388. The planetary gearbox 388 can be configured to transfer mechanical energy generated by the hydrogen engine 380 to both the generator 382 and the PTO 384. The PTO 384 is coupled to a hydraulic pump 386 to pressurize a hydraulic system to operate the hydraulic actuators of the refuse collection vehicle. The generator 382 is electrically coupled to a battery 308 and configured to charge the battery 308. The electric actuators of the refuse collection vehicle can be operated using the electricity generated by the generator 382 and/or stored in the battery 308.

In some implementations, the PTO 384 can be a hybrid electric PTO (ePTO) that can be powered by the mechanical energy generated by the hydrogen engine 380 and by electricity stored in the battery 308. The ePTO can convert electrical energy to mechanical energy for use by the hydraulic pump 386. Using an ePTO can be advantageous because the hydraulic system can be operated both with the hydrogen engine 380 running and without running the hydrogen engine 380 when the battery 308 has sufficient charge.

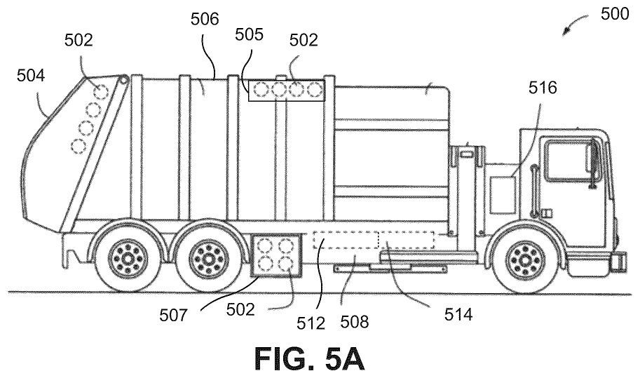

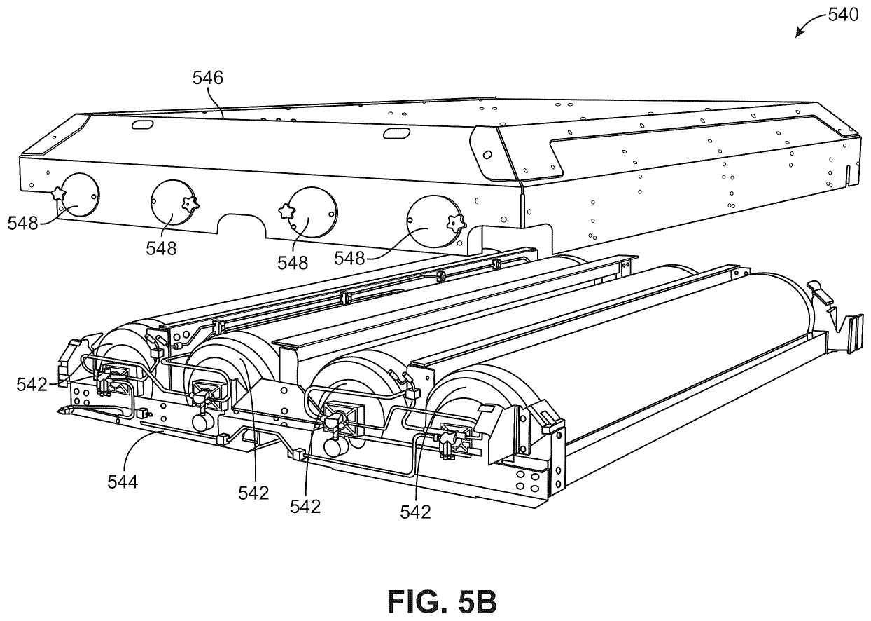

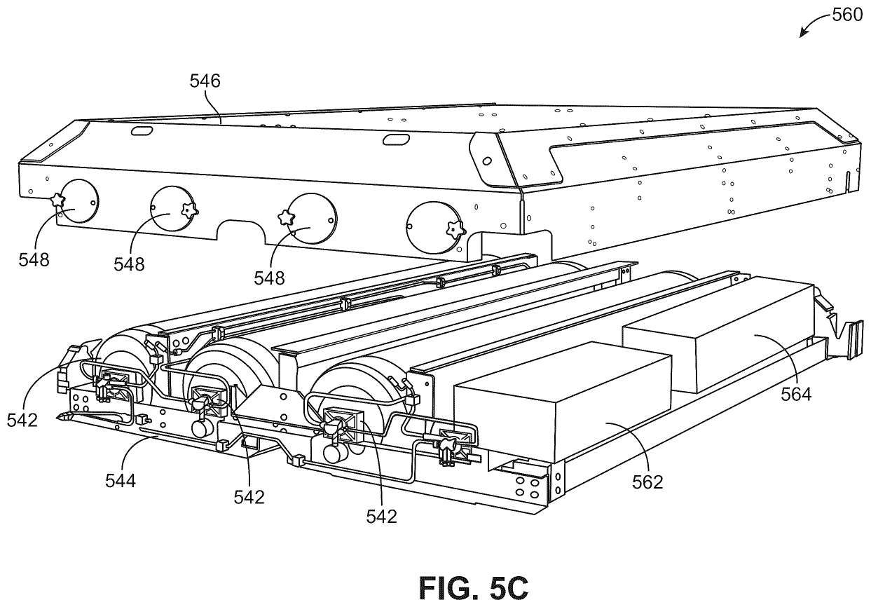

FIG. 5A illustrates locations on a refuse collection vehicle 500 where hydrogen tanks 502 can be stored. Hydrogen tanks 502 can be stored in the tailgate 504, in a pod 505 on a top surface 506 (e.g., roof) of the refuse collection vehicle 500, and/or in a pod 507 that is attached to a frame rail 510 of the refuse collection vehicle 500 along the side 508 of the refuse collection vehicle 500. The fuel cell 512 and battery pack 514 can be stored in the pod 505, 507 alongside the respective hydrogen tanks 502. Alternatively, or additionally, the fuel cell 512 and battery pack 514 can be stored outside of the pod(s) 505, 507. For example, the fuel cell 512 and battery pack 514 can be stored along the side 508 of the refuse collection vehicle 500 or near the chassis battery pack 516, as depicted in FIG. 5A. The fuel cell 512 and battery pack 514 can be located adjacent one another or in separate locations on the refuse collection vehicle 500. In some implementations, a hydrogen engine and a generator are used in place of the fuel cell 512 to generate electricity to charge the battery pack 514. In such implementations, the hydrogen engine and the generator can be located in the pods 505, 507 alongside the hydrogen tanks 502.

FIG. 5B illustrates an example pod 540 for storing hydrogen tanks 542. The pod 540 can be placed on a roof or some other surface around the top of a refuse collection vehicle (e.g., refuse collection vehicles 100, 200, 250, 280, 500). The pod 540 includes a base 544 that includes a carriage structure to secure the hydrogen tanks 542 in place. The base 544 can be attached to the roof of a vehicle by mechanical fasteners, for example, bolts or rivets. Alternatively, or additionally, the base can be welded to the roof of the refuse collection vehicle. The pod 540 also includes a cover 546 to protect the hydrogen tanks 542 from damage due to, for example, road debris or inclement weather. The cover 546 can be securely removably fastened to the base 544. The cover 546 also restricts access to the hydrogen tanks 542. The cover 546 includes apertures 548 to allow access to the hydrogen tanks 542 for inspection and/or refilling the tanks when the cover 546 is fastened to the base 544.

Placing the hydrogen tanks 542 on the roof of the refuse collection vehicle allows the refuse collection vehicle to be shorter as compared with a refuse collection vehicle with the hydrogen tanks stored on the tailgate, as shown in FIGS. 3, 4A, and 4B. This can be an advantage in locations where the length of the refuse collection vehicle is limited by law or practicality. The fuel cell and battery can be located in a separate location on the refuse collection vehicle and the hydrogen can be piped to the fuel cell. Similarly, the hydrogen engine and battery can be located in a separate location on the refuse collection vehicle and the hydrogen can be piped to the hydrogen engine.

FIG. 5C depicts another example configuration of a pod 560. The pod 560 is similar to pod 540 depicted in FIG. 5B, but pod 560 includes a fuel cell 562 and a battery pack 564 in place of one of the hydrogen tanks 542. In this configuration, the fuel cell 562 and battery pack 564 can also be attached to the roof of the refuse collection vehicle. In some implementations, the pod 560 includes a hydrogen engine and a generator in place of the fuel cell 562.

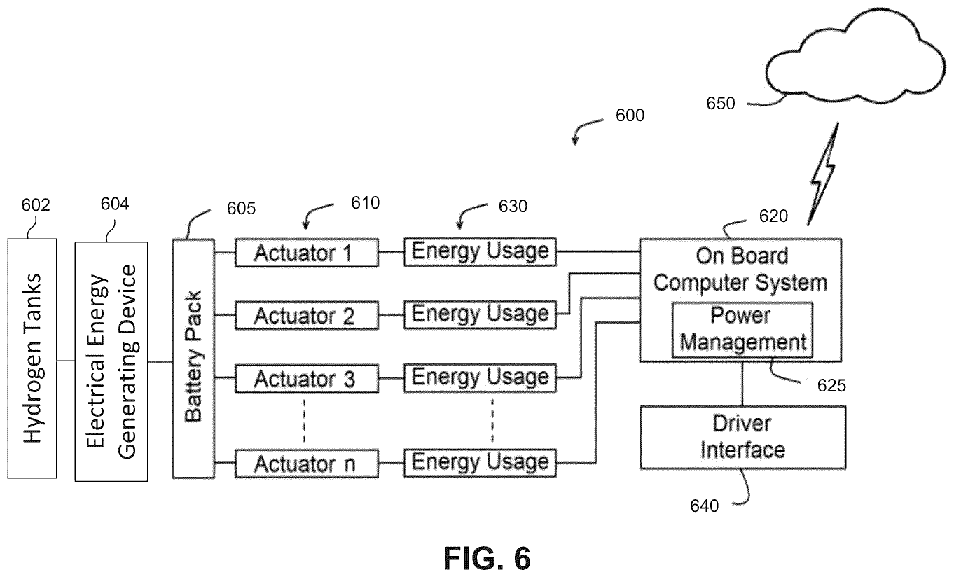

FIG. 6 depicts a schematic block diagram of an example power system 600 for a refuse collection vehicle. The power system 600 may be utilized in (or incorporated into) substantially any electrically powered refuse vehicle, all-electric vehicle body, partially electric body, or hybrid vehicle body, for example including the vehicles 100, 200, 250, 280, 500 depicted in FIGS. 1A-1B, 2A-2C, and 5A.

The power system 600 includes at least one hydrogen tank 602, an electrical energy generating device 604, and a battery pack 605. The hydrogen tank 602 provides fuel to the electrical energy generating device 604. In some implementations, the electrical energy generating device 604 is a fuel cell that includes an electrochemical cell that converts chemical energy of a fuel (e.g., hydrogen) and an oxidizer (e.g., oxygen from the air) into electricity. Alternatively, in some implementations, the electrical energy generating device 604 is a hydrogen engine coupled to a generator. The hydrogen engine combusts hydrogen gas converting chemical energy to mechanical energy. The generator converts the mechanical energy into electricity. The electrical energy generating device 604 can generate electricity continuously when supplied with fuel (e.g., from hydrogen tank 602). Thus, the amount of hydrogen stored in the hydrogen tanks 602 determines in part the amount of electricity that can be generated by the electrical energy generating device 604 before requiring refuelling.

The battery pack 605 can include one or more batteries or battery modules electrically connected together. In some implementations, the battery pack 605 includes a chassis battery pack (e.g., the chassis battery pack 231). The battery pack 605 receives electrical energy from the electrical energy generating device 604 to charge and/or maintain the charge of the battery (e.g., trickle charge). For example, the electrical energy generating device 604 can be configured to provide electrical energy to the battery pack 605 at a rate equal to the self-discharge rate of the battery pack 605 when the battery pack 605 is not in use thereby maintaining the charge of the battery pack 605. In other examples, the electrical energy generating device 604 can provide electrical energy to charge the battery pack when the charge of the battery pack 605 falls below a predefined threshold charge. The battery pack 605 stores electricity to operate electrical body components and systems of the refuse collection vehicle. For example, the battery pack 605 can power body components such as a lift arm (e.g., 260b, 284a), a fork mechanism (e.g., 284b), a grabber mechanism (e.g., 260a), a back gate or tailgate (e.g., 112, 212, 258), a hopper to collect refuse during operation (e.g., 262), and a packer (e.g., 225, 264). When coupled with an electrical energy generating device 604, a smaller battery pack 605 can be used to store power for the body components as compared with a system without a fuel cell or hydrogen engine. The battery pack 605 can be configured to provide larger peak currents to the body components (e.g., packer, ejector, loader) than the electrical energy generating device 604 can provide. For example, during operations requiring a large peak current draw, electricity stored in the battery pack 605 can be provided to power one or more body components of the refuse collection vehicle at a higher current than the maximum current generated by the electrical energy generating device 604. Increased current draws occur, for example, during operation of the packer, especially late in a route when packing densities are high. The electrical energy generating device 604 can recharge the battery pack 605 at a consistent rate. In some implementations, the peak current of the electrical energy generating device 604 is lower than the peak current of the battery pack 605, and the electrical energy generating device 604 recharges the battery pack 605 with the lower peak current. The electrical energy generating device 604 can be sized to generate electricity corresponding with an average power usage of the refuse collection vehicle. The battery pack 605 can be sized according to a peak current draw of the refuse collection vehicle. For example, peak current draw can exceed 400 amps. A stand-alone battery can exceed 50 kWh. In contrast, when coupled with a electrical energy generating device 604, the battery pack 605 can be sized considerably smaller than a stand-alone battery and provide the same power requirements because the electrical energy generating device 604 can keep the battery pack 605 charged throughout the course of the route. In implementations where the electrical energy generating device 604 is a hydrogen engine, the hydrogen engine can provide higher peak currents that can recharge the battery pack 605 in a shorter time period relative to implementations including a fuel cell.

In some implementations, the battery pack 605 is configured to harvest regenerative electricity created by some functions of the vehicle 100. These functions that produce regenerative electricity that can be harvested by the battery pack 605 can include, for example, lowering the tailgate of the vehicle (e.g., tailgate 112, 212) and lowering the lift arm(s) of the vehicle (e.g., side loader arms 260b, loader arms 284a).

Power system 600 includes a plurality of electric actuators 610 (e.g., actuator 1, actuator 2, actuator 3, and so on) deployed throughout the vehicle body and configured to electrically actuate the various body components described above (e.g., the electrically actuated tailgate 112, 212 the electrically actuated refuse ejector assembly 264, and the electrically actuated refuse loading assembly 260, 284 implementations described above). The actuators 610 are electrically coupled to the battery pack 605 from which they receive electrical power. As described above, substantially any suitable battery pack can be employed. For example, battery pack 605 can include the battery pack 308 shown in FIGS. 4A-4B.

The actuators 610 are in two-way electronic communication with an onboard computer system 620 that includes a power management module 625. The power management module 625 is configured to receive, record, and process energy usage data 630 from one or more (e.g., from each of) the actuators 610 during a refuse collection operation. As described in more detail below, the data 630 may be processed, for example, in real time during a refuse collection operation to automatically regulate the energy usage of the vehicle (e.g., to improve energy efficiency) and/or to provide feedback/coaching to the driver via the driver interface 640. Automatic improvement may be realized, for example, via controlling actuator speed or the actuation period of the various body components based on the energy usage measurements. Driver efficiency may also be improved, for example, by providing real time instructions/coaching to promote improved vehicle operation.

By real time it is meant that energy data collected during a collection operation (e.g., the vehicle's performance of a refuse collection route) is processed to provide automatic control or driver instructions during the same operation (e.g., during the same refuse collection route). The timeliness may depend, for example, on the quantity of data collected, the complexity of the processing, and whether or not cloud processing is implemented. In some implementations, real time can mean within 1 minute, 5 minutes, 10 minutes, 30 minutes, 1 hour, or two hours.

Note that the power management module may simply refer to a computer software routine configured to perform a particular task or particular tasks (e.g., related to vehicle power management). The routine can run, for example, on the onboard computer. The module may likewise refer to a platform including a combination of dedicated hardware and software configured to perform various tasks (e.g., the vehicle power management tasks in the disclosed implementations). Such hardware can include one or more processors and dedicated memory and can be in communication with or incorporated into the onboard computer.

With continued reference to FIG. 6, the vehicle computer system 620 can be in two-way communication (e.g., via a cellular network) with other internet based computing systems (e.g., the cloud 650). For example, the energy usage data 630 can be uploaded to the cloud 650 (e.g., to an online database) where it can be made available for further processing and evaluation. In some implementations, the energy usage data 630 is compared with fleet-wide energy usage data and further processed. Instructions for further efficiency improvements can be transmitted back to the computer system 620 where the data can again be used to automatically improve the energy efficiency of the vehicle and/or to provide feedback to the driver via interface 640.

The vehicle computer system 620 can monitor the charge status of the battery pack 605 and control the power generation of the electrical energy generating device 604 based on the monitored charge status. For example, if the battery charge falls below a specified threshold, the vehicle computer system 620 can control the flow of hydrogen from the hydrogen tanks 602 to the electrical energy generating device 604 and can control the electrical energy generating device 604 to generate electricity to charge the battery pack 605. Alternatively, or additionally, the vehicle computer system 620 can stop the flow of hydrogen and/or change the status of the electrical energy generating device 604 to stop generating electricity if the charge status of the battery pack 605 is above a specified threshold. In some implementations, the vehicle computer system 620 controls the power generation of the electrical energy generating device 604 to provide a trickle charge to the battery pack 605. For example, the vehicle computer system 620 controls the flow of hydrogen to the electrical energy generating device 604 to generate electrical energy and provide the electrical energy to the battery pack 605 at the same rate as the self-discharge rate of the battery pack 605.

In some implementations, an electric hydraulic pump can be used in place of one or more actuators 610. The electric hydraulic pump receives power from the battery pack 605 and pressurizes a hydraulic system to actuate a hydraulic actuator. The onboard vehicle computer system 620 can communicate with and control hydraulic actuators via the electric hydraulic pump.

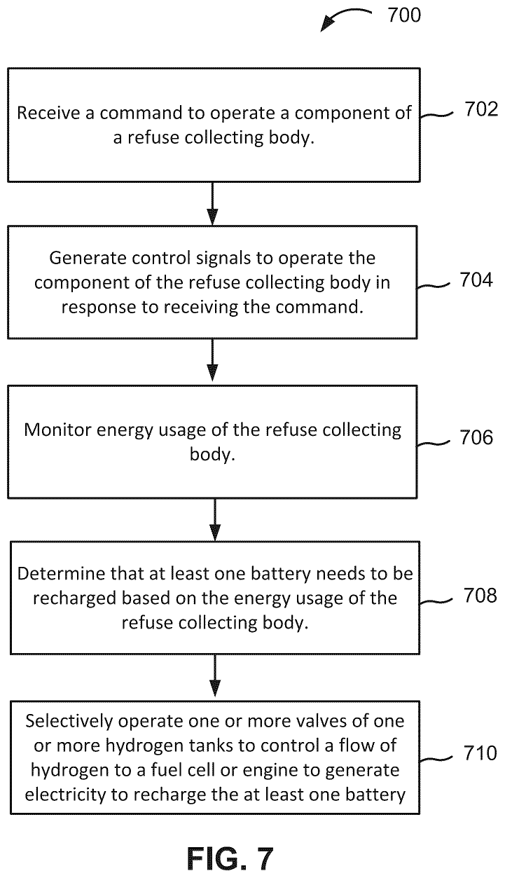

FIG. 7 is a flow chart of an example method 700 of operating a refuse collecting body of a refuse collection vehicle (e.g., refuse collection vehicle 100, 200, 250, 280, 500). The method 700 can be implemented by, for example, a controller or onboard computer system (e.g., onboard computer system 620).

The controller receives a command to operate a body component of the refuse collecting body (step 702). In some implementations, the body component includes a refuse loading assembly, a refuse packing assembly, or a tailgate. In some implementations, the component includes an electric hydraulic pump. In some implementations, the controller hydraulically actuates a body component of the refuse collecting body using power supplied by the electric hydraulic pump.

The controller generates control signals to operate the component of the refuse collecting body in response to receiving the command (step 704). For example, in response to receiving a command to move a tailgate of the refuse collection vehicle, the controller generates one or more control signals to actuate one or more actuators associated with the tailgate. In some implementations, the controller is configured to control one or more electrical switches that control the flow of electricity from at least one battery to the body components of the refuse collecting body in response to receiving the command.

The controller monitors energy usage of the refuse collecting body (step 706). For example, the controller monitors a charge status of the at least one battery of the refuse collecting body. In some implementations, the controller determines and monitors the amount of energy used by a body component during use of the body component.

The controller determines that the at least one battery needs to be recharged based on the monitored energy usage of the refuse collecting body (step 708). For example, the controller can determine that the at least one battery needs to be recharged by determining that the charge status of the at least one battery is below a threshold value. In some implementations, the controller can determine that the at least one battery needs to be recharged based on an amount of energy used by components of the refuse collecting body. In some implementations, the controller determines that the at least one battery needs to be recharged based on a rate of self-discharge of the at least one battery.

The controller selectively operates one or more valves of one or more hydrogen tanks to control a flow of hydrogen to a fuel cell or hydrogen engine to generate electricity to recharge the at least one battery (step 710). For example, the controller can operate the valves of the hydrogen tanks to provide a flow rate and/or a determined volume of hydrogen to the fuel cell or hydrogen engine sufficient to generate the electricity required to recharge the battery. In some implementations, the controller operates the valves of the hydrogen tanks based on the charge status of the at least one battery. For example, when the controller determines the at least one battery needs to be recharged, the controller opens the valves of the hydrogen tanks. When the controller determines the at least one battery does not need to be recharged, the controller closes the valves of the hydrogen tanks. In some implementations, the controller can control an operating status of the fuel cell or hydrogen engine (e.g., an on/off status).

In some implementations, the controller operates the valve(s) of one or more hydrogen tanks to recharge the at least one battery directly following actuation of a component of the refuse collecting body. In some implementations, the controller operates the valve(s) of one or more hydrogen tanks based on a discharge of the at least one battery. For example, the controller can determine that the at least one battery is being discharged, and in response to determining the at least one battery is being discharged, the controller operates the valve(s) of one or more hydrogen tanks to control the flow of hydrogen to the fuel cell or hydrogen engine in order to generate electricity to recharge the at least one battery.

In some implementations, the controller causes the measured energy usage to be displayed on a display device. In some implementations, the controller processes the energy usage data to generate usage recommendations for an operator to improve energy usage efficiency.

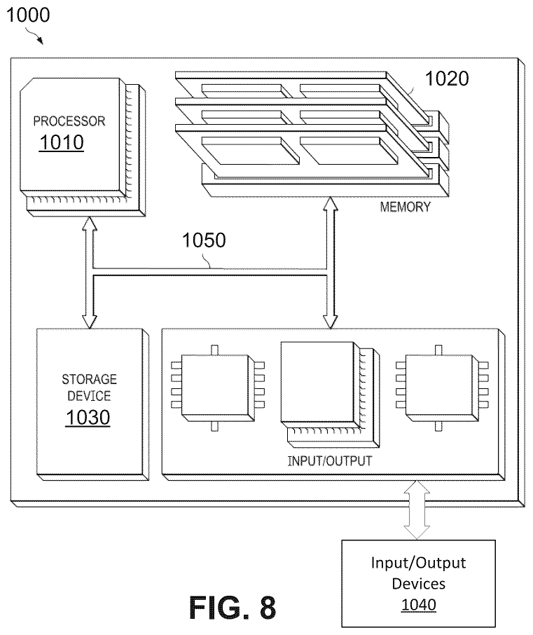

FIG. 8 is a schematic illustration of an example control system or controller for a refuse collection vehicle according to the present disclosure. For example, the controller 1000 may include or be part of the onboard computer system 620. The controller 1000 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the controller 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the controller 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the controller 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the controller 1000. In one implementation, the input/output device 1040 includes a joystick. In some implementations, the input/output device 1040 includes a display unit for displaying graphical user interfaces. For example, in some implementations, the input/output device 1040 is a display device that includes one or more buttons and/or a touchscreen for receiving input from a user. In some implementations, the input/output device 1040 includes a keyboard and/or a pointing device. In some implementations, the input/output device 1040 is located within a cab of a refuse collection vehicle (e.g., within cabin 108 of vehicle 100). For example, the input/output device 1040 can be attached to or incorporated within a dashboard inside the cab of a refuse collection vehicle.

A number of implementations of these systems and methods have been described. Nevertheless, it will be understood that various modifications may be made without departing from the spirit and scope of this disclosure. Accordingly, other implementations are within the scope of the following claims.

What is claimed is:

1. A refuse collection vehicle, comprising:
a chassis;
a refuse collecting body supported by the chassis;
a power generating assembly supported by the chassis, comprising:
at least one hydrogen tank;
a fuel cell fluidly coupled to the at least one hydrogen tank; and
at least one battery electrically connected to the fuel cell.

2. The refuse collection vehicle of claim 1, wherein the power generating assembly is coupled to the refuse collecting body.

3. The refuse collection vehicle of claim 2, further comprising a tailgate coupled to the refuse collecting body, wherein the at least one hydrogen tank, the fuel cell and the at least one battery are disposed on the tailgate.

4. The refuse collection vehicle of claim 3, further comprising one or more natural gas tanks disposed on the tailgate.

5. The refuse collection vehicle of claim 1, wherein the at least one hydrogen tank, the fuel cell and the at least one battery are disposed in a pod attached to a top surface of the refuse collecting body.

6. The refuse collection vehicle of claim 1, wherein the at least one hydrogen tank, the fuel cell and the at least one battery are disposed in a pod attached to a frame rail of the refuse collecting body.

7. The refuse collection vehicle of claim 1, further comprising at least one body component of the body, the at least one body component comprising a refuse loading assembly, a refuse packing assembly, or a refuse ejection assembly.

8. The refuse collection vehicle of claim 7, wherein the at least one body component comprises one or more electric actuators, wherein the at least one battery is configured to provide electrical power to the one or more electric actuators of at least one body component.

9. The refuse collection vehicle of claim 7, further comprising a hydraulic power system comprising an electrically powered hydraulic pump, wherein the hydraulic pump is configured to receive electrical power from the at least one battery; wherein the at least one body component comprises one or more hydraulic actuators.

10. The refuse collection vehicle of claim 1, further comprising a power management system comprising one or more processors configured to perform operations comprising: measuring power usage of one or more electrical components; and controlling power output of the fuel cell and the at least one battery.

11. The refuse collection vehicle of claim 1, wherein the chassis comprises a chassis battery pack and an electric motor configured to propel the vehicle, wherein the fuel cell is configured to charge the chassis battery pack.

12. The refuse collection vehicle of claim 1, wherein the chassis comprises an internal combustion engine configured to propel the vehicle.

13. The refuse collection vehicle of claim 12, further comprising one or more natural gas tanks coupled to the refuse collecting body, the one or more natural gas tanks fluidly coupled to the internal combustion engine.

14. The refuse collection vehicle of claim 1, wherein the refuse collection vehicle comprises a front loader refuse collection vehicle, a side loader refuse collection vehicle, or a rear loader refuse collection vehicle.

15. A method of operating a refuse collecting body of a refuse collection vehicle, the method comprising:
receiving a command to operate a component of the refuse collecting body;
in response to receiving the command, generating one or more control signals to operate the component of the refuse collecting body;
monitoring energy usage of the refuse collecting body;
determining that at least one battery needs to be recharged based on the energy usage of the refuse collecting body;
and
selectively operating one or more valves of one or more hydrogen tanks to control a flow of hydrogen from the one or more hydrogen tanks to a fuel cell to generate electricity to recharge the at least one battery.

16. The method of claim 15, wherein the component comprises a refuse loading assembly, a refuse packing assembly, or a tailgate.

17. The method of claim 15, wherein the component comprises an electric hydraulic pump.

18. The method of claim 17, further comprising hydraulically actuating the component of the refuse collecting body using power supplied by the electric hydraulic pump.

19. The method of claim 18, wherein the component comprises a refuse loading assembly, a refuse packing assembly, or a tailgate.

20. The method of claim 15, further comprising: electrically actuating the component of the refuse collecting body using energy stored in the at least one battery.

21. A refuse collection vehicle, comprising:
a chassis;
a refuse collecting body supported by the chassis;
a power generating assembly supported by the chassis, comprising:
at least one hydrogen tank;
a hydrogen engine fluidly coupled to the at least one hydrogen tank;
a generator mechanically coupled to the hydrogen engine; and
at least one battery electrically connected to the generator.

22. A method of operating a refuse collecting body of a refuse collection vehicle, the method comprising:
receiving a command to operate a component of the refuse collecting body;
in response to receiving the command, generating one or more control signals to operate the component of the refuse collecting body;
monitoring energy usage of the refuse collecting body;
determining that at least one battery needs to be recharged based on the energy usage of the refuse collecting body;
and
selectively operating one or more valves of one or more hydrogen tanks to control a flow of hydrogen from the one or more hydrogen tanks to a hydrogen engine to generate electricity to recharge the at least one battery.

23. A refuse collection vehicle, comprising:
a chassis;
a refuse collecting body supported by the chassis;
a power generating assembly supported by the chassis, comprising:
at least one hydrogen tank;
a hydrogen engine fluidly coupled to the at least one hydrogen tank;
a power takeoff coupled to the hydrogen engine; and
a hydraulic pump configured to receive mechanical energy from the hydrogen engine through the power takeoff.
